(19) United States
(12) Patent Application Publication
(10) Pub. No.: US 2026/0364545 A1
(43) Pub. Date: Nov. 19, 2026

(54) DEVICE AND METHOD FOR MIXING AT LEAST ONE FIRST AND ONE SECOND FLUID

(71) Applicant: austrian capital management GmbH, Salzburg (AT)

(72) Inventor: Hans-Christian BOETTGER, Haeusern (DE)

(73) Assignee: austrian capital management GmbH, Salzburg (AT)

(21) Appl. No.: 19/678,786

(22) Filed: May 15, 2026

(30) Foreign Application Priority Data
May 16, 2025 (EP) 25177025.1

(51) Int. Cl. B01F 23/43; B01F 23/41; B01F 29/80; B01F 35/30; B01F 35/32; B01F 35/45; B01F 35/51; B01F 35/71

(52) U.S. Cl. CPC B01F 23/43; B01F 23/41; B01F 29/80; B01F 35/3204; B01F 35/45; B01F 35/51; B01F 35/712; B01F 35/7179; B01F 2035/352; B01F 2215/0427; B01F 2215/0431; B01F 2215/0481

(57) ABSTRACT

Disclosed are a device for mixing at least one first and one second fluid having the following features, a corresponding method, and a closure element for the device and a system comprising device and closure element:
a mixing container (110) rotatable about an axis of rotational symmetry (112),
a drive unit (120), wherein the drive unit (120) is configured to rotate the mixing container (110) about the axis of rotational symmetry (112),
a first feed unit (140) having a first outlet (142), wherein the first feed unit (140) is configured, during operation, to continuously feed the first fluid to the mixing container (110) via the first outlet (142), wherein the first fluid is a liquid,
a second feed unit (150) having a second outlet (152), wherein the second feed unit (150) is configured, during operation, to feed the second fluid to the mixing container (110) via the second outlet (152),
   wherein the mixing container (110) is open at its upper side in order to discharge a liquid fluid mixture tangentially outward.

### FIELD OF THE INVENTION

The invention relates to a device for mixing at least one first and one second fluid, a corresponding method, a closure element, and a system for fluid mixing.

### BACKGROUND

Devices for mixing fluids are used in order, starting from different fluids, to obtain a fluid mixture which contains the different fluids. Within the meaning of this description, a fluid is understood in particular to be a substance which offers no resistance to sufficiently slow shearing. This includes in particular gases, liquids, and flowable multiphase systems in which at least one phase is gaseous or liquid. This includes, for example, aerosols which contain finely distributed solid particles, for example smoke, or liquid particles, for example mist, in a gas, usually air. Furthermore, emulsions, that is, mixtures of two generally immiscible liquids in which one liquid is distributed in the form of fine droplets in the other liquid, as well as suspensions, that is, heterogeneous material mixtures of a liquid and finely distributed solids therein, and granular fluids or granular media, for example flowable micro-dusts, are also to be understood as fluids within the meaning of this description.

A fluid mixture within the meaning of this description is a material system in which at least two fluids are mixed with one another, wherein one of the at least two fluids is a liquid. Such a fluid mixture may for example be a homogeneous solution of two miscible liquids or a gas dissolved in a liquid. Further examples are emulsions of two mutually immiscible liquids, dispersions such as foams, as well as homogeneously mixed systems of a suspension and a liquid. Also conceivable, for example, is a mixture of a colloidal suspension, such as solid nanoparticles in water, and a second liquid phase.

The mixing of two fluids is usually effected in that constituents of the individual fluids are repositioned by relative movement such that a new arrangement pattern is produced. For this purpose, the fluids involved are brought into contact and subjected to suitable mixing processes. For the mixing process, shear forces acting on the fluids are generally essential, which detach partial volumes of a fluid from their association in order to make them mobilizable and incorporate them into the other fluid. The strength and distribution of the shear forces depend substantially on the structural configuration of the respective mixing device.

Conventional devices for mixing fluids comprise, for example, agitators which mechanically engage in the fluid and mix it by rotation or translation, and so-called static mixers in which the fluids are guided through a geometrically structured mixing section. In the case of agitators, the shear forces that can be generated are limited by the geometry of the stirring member, the achievable rotational speed, and the mechanical load-bearing capacity of the components. It is disadvantageous that the high rotational speeds required for intensive mixing, in particular during emulsification, either lead to increased material fatigue and increased wear, which impairs the efficiency and service life of the device, or are simply not technically realizable with conventional drive units. In addition, the mixing quality, that is, the measure of the uniformity of the distribution of the fluids to be mixed or the size of the droplets of the disperse phase in an emulsion, asymptotically approaches a limit value with decreasing size of the entities, such as the individual droplets, particles, or bubbles which are produced or remain during the mixing process. This applies in particular to fine droplets in emulsions or particularly small particles in suspensions, in which further comminution or distribution is increasingly limited by physical or material-related limits, such as surface tension, viscosity, or particle interactions. Consequently, a further significant improvement of mixing beyond a certain size limit of the entities is practically no longer possible, or at least is severely restricted and associated with high technical expenditure, by conventional mechanical mixing methods.

Static mixers generate shear forces by flow guidance within stationary mixing elements. The intensity of the mixing is in this case dependent in particular on the flow velocity and on the number and geometry of the mixing elements used. It is disadvantageous that the flow velocity in such systems can be scaled only to a limited extent, since an increase often leads to pressure losses, undesired backflows, or structural loads on the installation. In addition, the number and geometry of the mixing elements are generally adapted to specific combinations of fluids, which restricts adaptability to different applications. Furthermore, static mixers tend to clog when processing solids-laden fluids, which may make increased cleaning expenditure or use as a disposable device necessary.

DE 44 07 331 A1 describes a device for gas enrichment in liquids, comprising a rotating part which is located in an atmosphere containing the gas to be enriched and on a surface of which a thin layer of the liquid can form, into which the gas diffuses, wherein the rotating part is a rotating hollow body, on the inner lateral surface of which the thin layer of the liquid can form as a result of the effect of centrifugal force, and wherein a feed line for the liquid into the interior of the hollow body and a discharge line for the liquid near the inner lateral surface thereof are provided in such a way that the section of the inner lateral surface in which the liquid is applied thereto is spaced apart from the discharge line in the axial direction.

DE 30 20 685 A1 describes a method for mixing liquid fluids of different quantity and viscosity, as well as a device for carrying out the method. In the method, the two quantities to be mixed are guided separately in two feed lines to a dosing point, at which the two quantities are subsequently mixed in a mixing container, wherein, after leaving the two feed lines, the two quantities of the fluids are guided onto a rotating end wall of a drum and are partially mixed in the drum, and the partially mixed quantities of the two fluids are flung through outlet openings in the shell of the rotating drum against a mixing container and are completely mixed there by the rotating drum.

JP 2001 286745 A describes a method and a device for mixing liquids or solutions, in particular a mixing method and a mixing device for producing photosensitive ultrafine particles from silver halide grains. The plurality of liquids or solutions to be mixed are fed into a rotation region of a stirring blade which is mounted in a rotating hollow body and rotates together with this hollow body, in order to mix the liquids or solutions by stirring.

### SUMMARY OF THE INVENTION

It is an object of the invention to provide an improved device and an improved method for mixing at least one first and one second fluid and furthermore to provide a closure element and a system for fluid mixing. The objects underlying the invention are solved by the features of the independent claims.

In one aspect, a device for mixing at least one first and one second fluid is disclosed, wherein the first fluid is a liquid. The device comprises a mixing container rotatable about an axis of rotational symmetry. The device further comprises a drive unit, wherein the drive unit is configured to rotate the mixing container about the axis of rotational symmetry. Furthermore, the device comprises a first feed unit having a first outlet, wherein the first feed unit is configured, during operation, to continuously feed the first fluid to the mixing container via the first outlet, wherein the first fluid is a liquid. The device further comprises a second feed unit having a second outlet, wherein the second feed unit is configured, during operation, to feed the second fluid to the mixing container via the second outlet. The mixing container is open at its upper side in order to discharge a liquid fluid mixture tangentially outward.

The mode of operation of the device is based fundamentally on the fact that, owing to mass inertia and as a result of the continuous feeding of the first fluid and the rotation of the mixing container, a liquid film or capillary, in the sense of a very thin, elongated liquid domain, forms on the inner wall thereof. Individual droplets of the second fluid, which likewise move radially outward owing to their mass inertia and aerodynamics, come into contact with this liquid film, are abrasively ablated by shear forces, and are incorporated into the liquid film in the form of very small partial volumes, whereby a fluid mixture is formed which is discharged via the upper opening of the mixing container.

For this purpose, the liquid first fluid is continuously fed to the mixing container during operation via the first feed unit, for example such that it impinges on the bottom of the mixing container. Upon entry, the liquid fluid impinges on a surface which moves about the axis of rotational symmetry. Since the liquid fluid is still at rest relative to the surroundings at the time of entry, the mass inertia of the fluid counteracts the rotation. The bottom surface transmits a tangential force to the liquid fluid by friction and viscous contact, whereby it is successively set into rotational movement and moved radially outward. Owing to its flow properties, it is distributed as a thin liquid film or capillary in the sense of a very thin, elongated liquid domain and is carried along with the inner wall of the mixing container.

The second fluid is introduced into the mixing container by means of the second feed unit via its second outlet, wherein the second outlet of the second feed unit is located, for example, above the first outlet of the first feed unit. Depending on the type of feeding of the second fluid, which may for example take place discontinuously, and the configuration of the second outlet, individual droplets of the second fluid form either directly at the second outlet or along the falling path between the second outlet and the bottom of the mixing container. Due to the rotation of the mixing container, the air located in the container is also set into rotation as a result of friction, which can be conceptually compared, in simplified terms, to a tornado-like vortex. The droplets are tangentially accelerated by friction with this likewise rotating air flow inside the mixing container and are guided by it in a radial direction toward the inner wall.

As a result, the droplets of the second fluid finally impinge on the liquid film or the capillary of the first liquid present on the inner wall. The smaller the initial distance of the droplets from the inner wall, the shorter the distance over which the droplets must be tangentially accelerated by the rotating air flow in the direction of the inner wall, and the more reliably the droplets are brought into contact with the liquid film. A velocity difference exists between the rotating liquid film and the droplets, whereby high shear forces come into effect at the contact surface between droplets and liquid film. These lead to abrasive ablation of the droplets, whereby partial volumes are detached from the droplet aggregate and incorporated into the liquid film. The mixing of the two fluids thereby takes place directly at the inner wall of the mixing container. The fluid mixture produced in this way is transported along the inner wall in the direction of the upper opening and is discharged there tangentially outward. For targeted control of the falling angle of the droplets relative to the mixing container, for example the mixing container or the mixing container together with the shaft which connects it to the drive unit, or for example the entire device, could be mounted so as to be adjustable with respect to its orientation in space. Via the falling angle, for example, the contact duration of the droplet with the liquid film or the capillary, and thus in turn the duration of the abrasive ablation of the droplet, could be influenced. This could for example enable a targeted redistribution of the constituents of the second fluid within the liquid film.

If the second fluid is a liquid immiscible with the first liquid, a fluid mixture is produced in the form of an emulsion in which the second fluid is present as the disperse phase and the first liquid as the continuous phase. The abrasive ablation of the droplet, caused by the high shear forces upon impingement on the liquid film, leads to the detachment of particularly small partial volumes from the droplet association, whereby the droplets of the second fluid in the emulsion have a very small size.

In order to prevent larger droplets from forming from the small droplets of the second fluid, emulsion stabilizers may be added to the first fluid, the second fluid, or the fluid mixture, for example surface-active compounds such as amphiphilic polymers, natural emulsifiers based on lipids or proteins, or cyclodextrins.

The likewise rotating air flow inside the mixing container furthermore produces a negative pressure in the center thereof. If the second fluid is, for example, an aerosol in the form of a mist, it is drawn into the central region of the mixing container and toward the bottom owing to the negative pressure and then rises again in a spiral movement along the inner wall. Analogously to the droplets described above, the droplets contained in the mist are also moved radially outward owing to their mass inertia and come into contact with the rotating liquid film or capillary formed on the inner wall and formed by the first fluid. There they are abrasively ablated and incorporated into the liquid film.

Such a device may provide the advantage that, for example, the mixing quality can be set in a targeted manner via the rotational speed. A further advantage could reside in that, at sufficiently high rotational speed and simultaneously small inner diameter of the mixing container, the shear forces arising upon contact of droplets and liquid film could exceed the values achievable in conventional mixing devices. As a result, even previously immiscible liquids could be mixed with one another, or particularly small droplet sizes of the disperse phase in emulsions could be achieved. This applies in particular when the second fluid is a highly viscous liquid, since correspondingly high shear forces are required for detaching individual partial volumes, such as generally cannot be generated, or can be generated only with high structural expenditure, with conventional mixing devices. A further advantage could be that, by adapting the rotational speed, the mixing process can be adapted particularly easily to specific combinations of fluids, which could increase flexibility for different applications.

According to one example in this regard, the drive unit is configured to rotate the mixing container about its axis of rotational symmetry at a rotational speed ≥150,000 rpm, in particular ≥200,000 rpm, in particular ≥300,000 rpm, in particular ≥339,000 rpm. This may provide the advantage that a particularly high mixing quality can be achieved by the shear forces thus obtainable, or that the mixing process can be accelerated. In addition, the mixing of two fluids which are not miscible, or only insufficiently miscible, at a lower rotational speed or with conventional devices may be enabled or improved.

According to a further example, the outlet of the first feed unit is positioned in the axis of rotational symmetry and the outlet of the second feed unit is positioned outside the axis of rotational symmetry. Positioning the outlet of the first feed unit in the axis of rotational symmetry may provide the advantage that the continuity of the liquid film formed by the first fluid is increased, since turbulence is avoided, such as could occur if the first fluid impinges on a region of the mixing container bottom outside the axis of rotational symmetry. The positioning of the outlet of the second feed unit outside the axis of rotational symmetry could furthermore have the advantage that the droplets formed come into contact with the liquid film more reliably and/or more quickly, since they do not have to cover the entire path from the axis of rotational symmetry to the inner wall and are not drawn centrally in by the air vortex produced by the rotation of the mixing container. This could in turn reduce the necessary height of the mixing container, which in turn could reduce the sensitivity of the device to imbalances.

According to a further example, the drive unit comprises a motor, wherein the motor is a brushless, permanent magnet three-phase motor or an induction motor with frequency converter or a compressed-air motor, and/or wherein the drive unit comprises a ceramic bearing, magnetic bearing, or air bearing. This may provide the advantage that particularly high rotational speeds could be reached owing to the low-friction and dynamically loadable construction of these motor types, with the mentioned bearing types additionally being able to contribute to minimizing friction and thermal load at high rotational speeds. Achieving such high rotational speeds could in turn lead to particularly high shear forces being generated, whereby the mixing quality is improved and even such fluids could be efficiently mixed with one another which are difficult or insufficiently miscible with conventional devices.

According to a further example, the drive unit comprises a shaft and the mixing container is connected to the shaft of the drive unit by means of a press fit. This may provide the advantage that, by the force-fitting and form-fitting connection, a particularly play-free, centered, and durable coupling between drive unit and mixing container could be achieved. Such a stable connection could enable higher rotational speeds without imbalances or relative movement between shaft and mixing container occurring. As a result, low-vibration running could be ensured and operational safety and uniformity of mixing could be improved.

According to a further example, the mixing container is cylindrical or the mixing container is conical with an inner diameter increasing toward the bottom. Alternatively or additionally thereto, the mixing container is smooth on the inside or comprises an upper inwardly beaded rim. This may provide the advantage that, by selecting these defined geometries of the mixing container, the liquid film could be formed and guided particularly uniformly. A cylindrical or conical inner contour could contribute to avoiding flow separation and promoting the formation of stable liquid films. For example, a conical geometry of the mixing container with an inner diameter increasing toward the bottom could contribute to a liquid film having a large thickness being formed before it leaves the mixing container via the upper opening. In addition, such shaping could favor higher rotational speeds, since it could support a more uniform mass distribution and thus smooth running. An upper inwardly beaded rim could for example delay the exit of the liquid film, in that the liquid film is briefly retained by the beaded rim, so that the layer thickness of the liquid film below the beaded rim increases until it exceeds the height of the beaded rim and the liquid film exits the mixing container. This could further increase the stability and continuity of the liquid film.

According to a further example, the mixing container consists substantially of titanium or a carbon-containing composite material. This may provide the advantage that, owing to the high tensile strength and the comparatively low density of these materials, higher rotational speeds may be enabled without the permissible tangential stress, which represents the main fracture criterion, being exceeded within the rotating mixing container. Since the tangential stress in a rotating, rotationally symmetric body is approximately proportional to the density of the material and to the square of the circumferential velocity, titanium or carbon-fiber-reinforced composite materials could enable operation at particularly high rotational speeds without failure of the container structure occurring. In particular, a mixing container consisting substantially of a carbon-fiber-reinforced composite material could enable particularly high rotational speeds owing to the even lower density compared with titanium, with at least unchanged tensile strength. Rotational speeds of up to 1,000,000 rpm are conceivable, for example.

According to a further example, the mixing container has a maximum inner diameter of ≤10 cm, in particular ≤1.5 cm, in particular ≤0.7 cm, and/or a height in a range from 0.01 cm to 20 cm, in particular 0.1 cm to 10 cm, in particular 0.5 cm to 2 cm, in particular 0.7 cm to 1.2 cm. This may provide the advantage that, from an inner diameter in the specified range, assuming a given rotational speed, a lower circumferential velocity results than in the case of containers having an inner diameter above these ranges. This could reduce the mechanical load on the mixing container and increase operational safety. At the same time, owing to the comparatively small radius of curvature, assuming a given rotational speed, particularly high inertial forces could act on the fluids to be mixed, which could increase the shear intensity and improve the efficiency of the mixing process.

To illustrate a further possible advantage, an exemplary mixing container having an inner diameter of 0.7 cm in combination with a rotational speed of 339,000 rpm is assumed. Such a combination would lead, according to the following relationship, to a circumferential acceleration a acting on the inner wall of the mixing container of about 450,000 times the acceleration due to gravity (g):

a=ω²·r

The angular velocity ω results from the rotational speed:

$$ω = \frac{( 2 π \cdot n )}{60}$$

When n=339,000 rpm and r=0.0035 m (->inner diameter of mixing container=0.7 cm) are inserted, the result is

$$a = {( \frac{2 π \cdot 339000}{60} )}^{2} \cdot 0 , 0035 \approx 4.42 \text{.000} m / {s}^{2} \approx 450. g$$

Thus, in this example, an inertial force corresponding to this acceleration would also act on the molecules within the liquid film, which could influence their movement, interaction, and in particular orientation in the liquid film. Without being bound by theory, it is assumed that molecules having an asymmetric mass distribution align in this way in the acceleration field, so that, for example, certain functional groups or regions of the molecules of the first fluid are oriented in the direction of the axis of rotational symmetry of the mixing container and thus also in the direction of the trajectory of the droplets of the second fluid moving tangentially outward. In other words, these functional groups are exposed in the direction of the center of the mixing container. Without being bound by theory, it is assumed that competing reactions can thereby be controlled in a targeted manner, since the probability is increased that the relative orientation of the molecules with respect to one another required for a certain one of mutually competing reactions is present at least to a certain degree more frequently when the molecules encounter one another than would be the case, for example, in the statistical mean in a mixture stirred by means of an agitator.

It would likewise be conceivable that, by a corresponding exposure of reactive groups, less reactive groups or sterically shielded regions of the molecules are more likely to face away from the molecules contained in the droplet, and thus the reaction rate between the molecules located in the droplet and those in the liquid film could be increased. In particular, the combination of small inner diameter and high rotational speed could be advantageous in this context, since it could bring about a particularly strong orientation of the molecules in the liquid film while the circumferential velocity is simultaneously limited. In this way, in addition to the pure mixing of two liquids, targeted reaction control could also be a further possible application of the device.

A height of the mixing container in the specified range could reduce the sensitivity of the device to imbalances, since the moment of inertia is reduced with smaller overall height and thus the effects of asymmetric mass distributions could be attenuated, which, in particular at high rotational speeds, could contribute to avoiding unstable operating states or structural failure.

According to a further example, the device is configured such that the orientation of the mixing container is adjustable about three spatial axes. The adjustability about three spatial axes comprises, for example, a yaw movement about a vertical axis, a pitch movement about a horizontal transverse axis, and a roll movement about a horizontal longitudinal axis. This could for example be realized by a positioning device having a platform on which the device is fastened, wherein the construction thereof substantially resembles a tracking device for telescopes. It would likewise be conceivable that, alternatively or additionally, the mixing container together with the shaft which connects it to the drive unit, or the entire device, is adjustable about three spatial axes. This could for example be realized by means of a ball head or by means of geared tilt heads. This may provide the advantage that targeted control of the falling angle of the droplets relative to the mixing container would be particularly simple, reproducible, and, depending on the configuration, in particular also adaptable during operation. By the targeted selection of the falling angle, the contact duration between droplet and liquid film could be influenced, whereby the distribution of the constituents of the second fluid within the film could be controlled in a targeted manner.

According to a further example, the circumferential velocity of the mixing container during operation is at most 1230 km/h. This may provide the advantage that a sonic boom could be avoided during operation of the mixing container. Such a boom arises when the circumferential velocity locally exceeds the speed of sound in the surrounding air, which leads to sudden compression and shock-wave formation. By limiting the circumferential velocity to a value below the speed of sound in completely dry air, that is, about 1230 km/h at 20 °C, entry into the transonic or supersonic range could be prevented.

According to a further example, the distance of the first outlet from the bottom of the mixing container is ≤1 mm, in particular ≤0.1 mm. This may provide the advantage that, during the continuous feeding of the first fluid, a liquid bridge between the first fluid in the first outlet and the liquid film located in the mixing container could be maintained. Such a continuous liquid bridge could promote uniform feeding and avoid undesired air inclusions or interruptions during feeding, which in turn could improve the stability and homogeneity of the liquid film being formed.

According to a further example, the mixing container is arranged in an enclosure, wherein the enclosure is configured to protect the drive unit from fluid contact and/or to collect liquid fluid mixture discharged tangentially from the mixing container, in particular wherein a gap for preventing contact between mixing container and enclosure is present between the outer wall of the mixing container and the inner wall of the enclosure, in particular wherein the gap has a width in the range from 0.05 mm to 0.5 mm, in particular from 0.2 mm to 0.4 mm. This may provide the advantage that the drive unit could be effectively protected by the enclosure from direct fluid contact, for instance if the liquid film exiting tangentially upward from the mixing container or the discharged fluid mixture passes in the direction of the drive unit. A gap between mixing container and enclosure in the specified dimensions could furthermore ensure that no mechanical contact occurs, even in the event of thermal expansion or minimal imbalances, which could contribute to operational safety and service life of the device.

According to an example in this regard, a discharge channel is arranged below the gap, wherein the discharge channel is spatially separated from the drive unit and receives the portion of the fluids or of the fluid mixture which has passed through the gap, in particular wherein the discharge channel consists of mutually connected, in particular labyrinth-like mutually connected, cavities, in particular wherein one of the mutually connected cavities has a region in which a portion of the fluid received by the discharge channel remains. This may provide the advantage that fluid which has passed through the gap could be collected in a targeted manner and kept away from the drive unit in order to protect it from contamination and thus minimize wear thereof. The use of mutually connected cavities could increase the receiving volume of the discharge channel and, for example, enable more efficient utilization of the space inside the housing. A labyrinth-like connection of the cavities could lengthen the flow path and thus delay the passage of fluid through the channel. Retention regions within individual cavities could ensure that received fluid is initially retained and is passed on only after the cavity has been completely filled, which could further delay the passage of fluid through the channel. Such retention regions could likewise ensure that not the entire quantity of the fluid received by the discharge channel exits from the latter, but rather a portion remains in the discharge channel and is removed from the discharge channel, for example, via other routes, such as through an additional outlet or by suctioning the fluid out of the discharge channel, whereby the quantity of fluid that can collect inside the housing outside the discharge channel would be reduced.

According to an example in this regard, the device comprises a gas feed unit, wherein the gas feed unit is configured to conduct a gas through the gap and/or the discharge channel in order to protect these from fluid entry. This may provide the advantage that, by introducing a gas flow, for example compressed air or a protective gas such as argon, CO2, nitrogen, or helium, fluid already located in the gap or discharge channel could be displaced or removed counter to the flow direction. At the same time, the entry of fluid into these regions could be prevented or at least reduced by the oppositely directed gas flow, whereby additional protection of the drive unit against contamination could be achieved. A further advantage of this example could be that the targeted introduction of an inert protective gas could prevent oxidation-sensitive constituents of the fluid or of the fluid mixture from coming into contact with oxygen and thereby undergoing an oxidative reaction.

For example, the enclosure could comprise a lid, wherein the lid can be opened in order, for example, to provide access to the mixing container. For example, the lid could additionally be removable from the enclosure. The lid could for example be formed as an integral but movable part of the enclosure, for example by means of a hinge or a flexible connection. Alternatively, the lid could for example also be formed as a separate component which can be removed from the enclosure and is attached to the enclosure, for example, by means of a mechanism such as a screw closure, a bayonet connection, a latching connection, a snap closure, or a clamping device. This could for example have the advantage that access to the mixing container is facilitated and thus, for example, adjustment or maintenance operations would be facilitated, wherein in the closed state effective protection against the entry of undesired foreign material into the mixing container or other components of the device remains ensured.

Furthermore, an advantage could for example be that the lid prevents or at least reduces the escape of gaseous constituents, in particular evaporated liquid constituents of the fluids or of the fluid mixture, from the enclosure. The lid could thus prevent or at least reduce further evaporation of a liquid fluid after an equilibrium state between condensation and evaporation has been established. Thus, for example, an aerosol produced in the mixing container during operation and distributed in the enclosure owing to its fluid properties could be protected from the loss of its liquid constituents, which could be advantageous in particular owing to the high surface-to-volume ratio in the case of small droplet sizes of aerosols.

For example, the lid could close the enclosure in a gas-tight or at least substantially gas-tight manner, for example with respect to water vapor. This could for example further reduce or prevent the escape of gaseous constituents, in particular evaporated liquid constituents of the fluids or of the fluid mixture.

According to a further example, the mixing container is positioned in a region in which a protective gas atmosphere is present and/or in which a negative differential pressure relative to the air pressure of the room in which the device is located prevails and/or in which a pressure of less than 1013 hPa prevails. This may provide the advantage that, by targeted generation of a negative pressure or a protective gas atmosphere, the influence of ambient air on the fluids or the fluid mixture could be reduced. A pressure reduction, in particular to a fine vacuum or an ultra-high vacuum, could reduce friction losses between the rotating mixing container and the surrounding air and thereby increase the efficiency of the drive. A protective gas atmosphere, for example of argon, CO2, nitrogen, or helium, could moreover protect oxidation-sensitive or hydrolysis-sensitive constituents of the fluids used or of the fluid mixture from chemical change. In addition, a protective gas atmosphere, in particular a protective gas atmosphere based on helium or hydrogen, could likewise reduce friction losses owing to the lower density compared with air and the associated reduced aerodynamic resistance, without causing the lowering of the boiling point of the fluids used which accompanies a pressure reduction. In this regard, both enclosure of the entire device and partial chambering, in which only the mixing container or its immediate surroundings is operated under negative pressure or in a protective gas atmosphere, are conceivable.

In a further aspect, a closure element for a device according to any of the preceding examples is disclosed, wherein the closure element is designed for positioning at least one of the feed units. The at least one of the feed units is an integral component of the closure element, or the closure element is configured to be able to position the at least one of the feed units, in particular in a positionally fixed manner, in particular the closure element consisting substantially of a material suitable for thermal sterilization methods, in particular autoclavable material. This may provide the advantage that precise positioning of the feed unit into a position suitable for operation of the device is enabled or at least facilitated. This could be achieved, for example, in that the feed unit, as an integral component of the closure element, is fixed directly in the desired position as soon as the closure element is attached to the device in a predetermined orientation and at a predetermined location. If the closure element is designed such that it is capable of positioning the feed unit in a positionally fixed manner, the latter could for example be received in the closure element by means of a bayonet connection before or after it is attached to the device, and thus fixed in the position suitable for operation. If the closure element consists substantially of a material suitable for thermal sterilization methods, in particular autoclavable material, this may provide the advantage that sterilization could be facilitated, which could increase the hygiene level and additionally or alternatively enable reuse of the closure element, which in turn could increase sustainability and reduce operating costs.

In a further aspect, a system for fluid mixing is disclosed, comprising a device according to any of the preceding examples and a closure element according to the preceding aspect, wherein in particular in the event that the device is arranged in an enclosure, wherein the enclosure is configured to protect the drive unit from fluid contact and/or to collect liquid fluid mixture discharged tangentially from the mixing container, the closure element forms at least a part of the enclosure. This may provide the advantage that the geometry of the closure element and of the device could be matched to one another and thus compatibility with one another could be ensured. In this way, the positioning of the feed units could furthermore be enabled particularly precisely, simply, and repeatably.

In a further aspect, a method for mixing at least one first and one second fluid is disclosed, in which a device according to any of the preceding examples is used. The method comprises providing the device, rotating the mixing container about its axis of rotational symmetry, in particular at a rotational speed of at least 150,000 rpm, feeding the first fluid, which is a liquid, through the first feed unit into the mixing container, and feeding the second fluid through the second feed unit into the mixing container. Furthermore, the method comprises discharging the fluid mixture produced in the mixing container via its upper opening in a tangential direction outward and subsequently collecting the fluid mixture and/or feeding the fluid mixture to a filtration device.

According to an example in this regard, the distance of the first outlet from the bottom of the mixing container could be selected such that, during operation, a liquid bridge between the first fluid in the first outlet and the supplied first fluid in the mixing container would be maintained. In this way, for example, the continuity of the feeding of the first fluid could be ensured, since undesired tearing-off of the liquid stream would be reduced or avoided. This in turn could contribute to uniform formation of the layer thickness of the liquid film and promote complete wetting of the entire inner wall of the mixing container.

Otherwise, the features and advantages relating to the device for mixing at least one first and one second fluid can be transferred correspondingly to the method for mixing at least one first and one second fluid, so that further repetitions can be dispensed with at this point.

It is understood that one or more of the aforementioned examples may be combined with one another as long as the examples do not mutually exclude one another.

### BRIEF DESCRIPTION OF THE DRAWINGS

In the following, examples are explained in more detail with reference to the figures. The figures show:

FIG. 1 a sectional illustration of an exemplary device for mixing at least one first and one second fluid,

FIG. 2 a sectional illustration of a further example of a device for mixing at least one first and one second fluid,

FIG. 3 a sectional illustration of a further example of a device for mixing at least one first and one second fluid,

FIG. 4 a sectional illustration of an exemplary system for fluid mixing,

FIG. 5 a sectional illustration of a further example of a system for fluid mixing,

FIG. 6 a sectional illustration of a further example of a system for fluid mixing,

FIG. 7 a sectional illustration of a further example of a system for fluid mixing, and

FIG. 8 a flow diagram of an exemplary method for mixing at least one first and one second fluid.

### DETAILED DESCRIPTION

In the following, elements similar to one another are identified by the same reference signs.

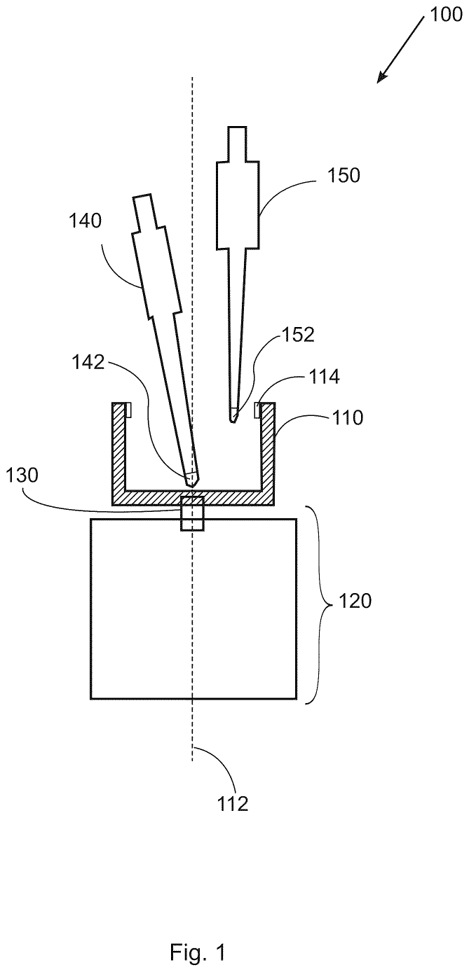

FIG. 1 shows a sectional illustration of an exemplary device 100 for mixing at least one first and one second fluid. The device serves to mix at least one first and one second fluid with one another, wherein the first fluid is a liquid. In the following, without limiting generality, it is to be assumed that both the first and the second fluid are liquids. It is for example likewise conceivable that the second fluid is an aerosol of finely distributed droplets in air, that is, colloquially, a mist.

The mixing container 110 is rotated by the drive unit 120 about its axis of rotational symmetry 112. In the non-limiting example of FIG. 1, the mixing container optionally has an inwardly beaded rim 114 at the top on the inside. In addition, the drive unit comprises a shaft 130, which for example connects the drive unit 120 to the mixing container 110 by means of a press fit in order to transmit the rotation of the shaft 130 to the mixing container 110 and to rotate the latter, for example, at a rotational speed ≥150,000 rpm, in particular ≥200,000 rpm, in particular ≥300,000 rpm, in particular ≥339,000 rpm, about its axis of rotational symmetry.

For example, the mixing container 110 has an inner diameter of ≤10 cm, in particular ≤1.5 cm, in particular ≤0.7 cm.

The first fluid, which is a liquid, is continuously fed to the mixing container 110 via the first feed unit 140, the first outlet 142 of which is positioned in FIG. 1 in the axis of rotational symmetry 112. For example, the first feed unit and/or its outlet is inclined relative to the axis of rotational symmetry; an orientation along the axis of rotational symmetry is likewise also conceivable. For example, the distance of the first outlet 142 from the mixing container bottom lies in a range from 0.1 mm to 1.0 mm, whereby, at a sufficiently high flow rate of the first fluid through the first outlet 142, a liquid bridge between the first fluid in the first outlet 142 and the supplied first fluid in the mixing container 110 is maintained. For this purpose, the distance selected during operation could for example be adapted to the combination of viscosity of the first fluid, rotational frequency of the mixing container, and flow rate of the first fluid through the first outlet 142. The first feed unit 140 could for example be formed as a capillary, micro-nozzle, needle, pipette channel, temperature-controlled feed line, or as a controllable dosing opening. For example, the first feed unit 140 could be formed as a cannula/hollow needle, wherein the cannula/hollow needle could for example have an inner diameter <1 mm. In this regard, the fluid feed may take place actively or passively, for example by means of pressure difference, capillary force, a peristaltic pump, syringe pump or perfusor, or via a clocked system controlled by means of a valve. The first feed unit 140 could moreover be heated or thermally insulated in order to minimize temperature influences on the first fluid.

Due to the rotation of the mixing container 110, the supplied liquid first fluid is moved to the inner wall of the mixing container 110 owing to mass inertia and forms there, for example, a continuous liquid film over the entire surface of the inner wall. Via the opening at the upper side of the mixing container 110, the liquid film is discharged tangentially outward from the mixing container. For example, the exit of the liquid film is delayed by the beaded rim 114 on the inner wall of the mixing container 110 in order to increase the layer thickness of the liquid film below the beaded rim 114 before exit from the mixing container 110 occurs. For example, without the beaded rim 114, instead of the liquid film, a capillary in the sense of a very thin, elongated liquid domain could also form.

The second feed unit 150, the second outlet 152 of which is positioned outside the axis of rotational symmetry 112 in the non-limiting example of FIG. 1, serves for metered feeding of the second fluid into the rotating mixing container 110. The second feed unit 150 could for example be formed analogously to the first feed unit 140. The second outlet 152 of the second feed unit 150 is positioned, for example, above the first outlet 142 of the first feed unit 140. The feeding of the second fluid takes place, for example, discontinuously and/or at a low flow rate in order to cause the formation of individual droplets consisting of the second fluid. Alternatively or additionally, for example, a fine liquid jet could also be introduced into the mixing container through the second feed unit 150. For targeted control of the outlet form, droplet formation versus liquid jet, and of the outlet rate, the second feed unit 150 could comprise a liquid control device, for example a valve system, a speed-controlled pump, or a time-controlled syringe pump, perfusor.

The second feed unit 150 could for example be formed analogously to the first feed unit 140. In this regard, the formation of the second outlet 152 could be selected such that droplets are formed in a targeted manner by suitable wetting and geometry conditions. The minimum distance of the second outlet 152 from the bottom of the mixing container is selected such that it is greater than the mean diameter of a droplet of the second fluid. In this way, it is avoided that the fluid directly impinges on the bottom, whereby the targeted droplet formation and movement thereof to the inner wall can take place undisturbed. For example, the minimum distance, in the event that the second fluid is a liquid, may lie in the range from 0.5 mm to 5 mm. In the event that the second fluid is a mist, the minimum distance could for example be selected in the range from 0.1 μm to 0.5 mm, since fundamentally the droplets in the mist are considerably smaller than those which form upon discharge of a liquid under standard conditions. Therefore, in this case, even a smaller distance is sufficient to ensure that the finely distributed mist droplets come into contact with the liquid film on the inner wall of the rotating mixing container 110. It is conceivable that the position of the second outlet 152 is generally adjustable or controllable or readjustable during operation.

It would likewise be conceivable that the second feed unit comprises means for nebulizing a liquid, for example in the form of an ultrasonic nebulizer or a bubble-jet system. Furthermore, further known nebulization techniques are conceivable, such as pressure nozzles, piezo elements, electrohydrodynamic nebulizers, EHD nebulizers, or rotary atomizers.

In the non-limiting example of FIG. 1, the drive unit 120 comprises a motor, for instance an electric motor, for example in the form of a brushless, permanent magnet three-phase motor or an induction motor with frequency converter. The motor may likewise be a compressed-air motor. The mentioned motors are particularly suitable, owing to the high rotational speeds achievable with them, for rotating the mixing container 110 at high rotational frequency about its axis of rotational symmetry 112, for example at more than 300,000 rpm. The drive unit 120 comprises, for example, ceramic bearings, magnetic bearings, or air bearings which, owing to their contactless or virtually friction-free mounting, could enable particularly high rotational speeds or minimize wear at high rotational speeds. While magnetic bearings and air bearings operate contactlessly and thereby practically have no mechanical contact between rotating and stationary components, ceramic bearings, although not contactless, could likewise be particularly suitable for use at high rotational speeds owing to their high hardness, temperature resistance, and low coefficients of friction. For example, the shaft 130 is mounted in this regard via such a bearing in the motor of the drive unit 120.

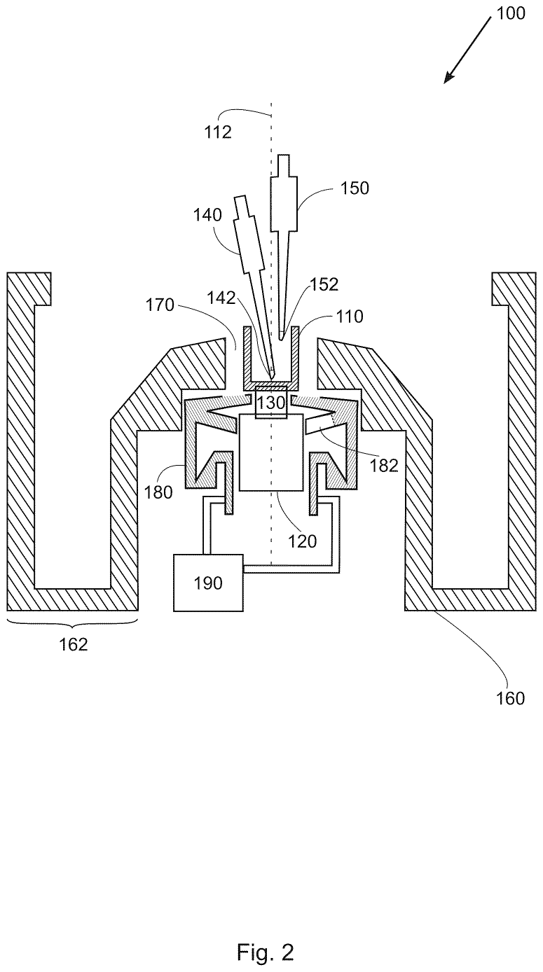

FIG. 2 shows a sectional illustration of a further example of a device 100 for mixing at least one first and one second fluid. The exemplary device 100 corresponds to that from FIG. 1, the beaded rim 114 not being shown in FIG. 2, wherein the mixing container 110 is arranged in an enclosure 160. The enclosure 160 serves for example to protect the drive unit 120 and its components, such as the shaft 130 and bearings, from contact with fluids, such as the first fluid, the second fluid, or the fluid mixture. In addition, the enclosure 160 could likewise serve to protect against the entry of dust or other contaminants into the drive unit 120. In the following, without limiting generality, for the sake of clarity it is assumed that the protection of the drive unit 120 from fluid contact is effected. In the non-limiting example of FIG. 2, a gap 170 between the outer wall of the mixing container 110 and the inner wall of the enclosure 160 is furthermore shown in order to prevent contact between mixing container 110 and enclosure 160. In FIG. 2, the gap 170 is shown relatively wide in relation, for example, to the mixing container 110 for better illustration. Technically appropriately, the gap 170, which is not necessarily shown to scale, could for example have a width in the range from 0.05 mm to 0.5 mm, in particular from 0.2 mm to 0.4 mm.

As additional protection of the drive unit 120 against fluid contact, a discharge channel 180 is arranged below the gap 170 in the example of FIG. 2. The discharge channel 180 could for example be connected to the gap 170 or be arranged at a small distance below the gap 170 such that fluid which undesirably passes through the gap 170 reaches the discharge channel 180 and is received by the latter. In the non-limiting example of FIG. 2, the discharge channel extends to below the mixing container in the direction of the shaft in order to be able to receive as far as possible all of the fluid that has passed through the gap 170. The discharge channel 180 is spatially separated from the drive unit 120, in that it is positioned for example, as in FIG. 2, outside the outer wall of the drive unit 120 and spaced apart therefrom. It is likewise conceivable that a wall is additionally or alternatively provided between the drive unit 120 and the discharge channel 180. If fluid or fluid mixture undesirably enters the gap 170 and passes through it, the discharge channel 180 could guide this portion of the fluid past the drive unit 120, so that the fluid cannot come into contact with the drive unit 120. For this purpose, for example, the lower end of the discharge channel 180 is located below the drive unit 120, so that even fluid exiting from the lower end of the discharge channel 180 cannot come into contact with the drive unit 120. It is likewise conceivable that the lower end of the discharge channel 180 is not located below the drive unit 120, in particular if the distance between discharge channel 180 and drive unit 120 is selected sufficiently large and additionally or alternatively an additional wall is provided for spatial separation, by which contact between exiting fluid and the drive unit 120 can be reliably prevented.

For example, the discharge channel 180 consists of mutually connected cavities in order to enlarge its volume and thus also the receiving capacity of the discharge channel 180 for fluids or other undesired substances such as dust. So that fluid received by the discharge channel 180 does not flow directly through it and leave the discharge channel 180 again, a plurality of retention regions 182 are provided in the example of FIG. 2, one of which is explicitly shown on the right next to the drive unit 120 in FIG. 2. Such a retention region 182 is formed, for example, as part of a cavity. For example, one, several, or all of the cavities could have such a retention region 182. Fluid entering such a cavity could successively fill it completely, wherein the fluid exits the cavity again in the flow direction only when the retention region 182 is completely filled and, as a result, the fluid passes over the highest point of the retention region 182. If fluid from this cavity, for example, already enters the connection to another cavity or exits from the end of the discharge channel 180 and no additional fluid from the gap 170 is received by the discharge channel 180, the fluid flows out of the retention region 182 only until the level of the fluid has again reached the height of the highest point of the retention region 182.

In order to lengthen the path of the channel and further increase its volume and thus prevent, or at least reduce or delay, the flow through the discharge channel 180, the cavities shown in FIG. 2 are connected to one another in a labyrinth-like manner.

Alternatively or additionally to the protection of the drive unit 120 from fluid contact, the enclosure 160 could for example serve to collect the discharged fluid mixture. For this purpose, a reservoir 162 is implemented in the non-limiting example of FIG. 2, which could collect the discharged fluid mixture. For this purpose, a wall is provided at the outer region of the enclosure 160, which projects beyond the opening of the mixing container 110, so that the fluid mixture discharged tangentially from the mixing container 110 impinges on this wall and flows on it into a cavity formed by the reservoir 162. It is likewise conceivable that the discharged fluid mixture passes directly into the cavity formed by the reservoir 162 without touching the wall projecting beyond the mixing container 110.

As further protection of the drive unit 120 from fluid contact and the entry of contaminants, a gas feed unit 190 is provided in the non-limiting example of FIG. 2, which in this example is connected to the discharge channel 180. The connection may in this regard for example be configured such that fluid exiting from the discharge channel 180 cannot enter the gas feed unit 190, for instance by suitable spatial separation or a backflow barrier. Through the gas feed unit 190, compressed air or a gas, in particular a protective gas such as argon, nitrogen, or helium, can be conducted counter to the flow direction of the fluid through the discharge channel 180 and at the same time also through the gap 170 connected to the discharge channel 180. In this case, the discharge channel 180 simultaneously acts as a feed channel for the gas into the gap 170. In this way, the entry of fluid into the gap 170 could be prevented or at least reduced. Fluid already having entered the gap 170 could also be displaced upward out of the gap 170 in the opposite direction by the gas flow generated by the gas feed unit 190. The same applies to fluid which has already entered the discharge channel 180, for example such fluid located in a retention region 182. It is likewise conceivable that the gas feed unit 190 is connected directly to the gap 170 and conducts an ascending gas flow from bottom to top exclusively through the latter.

The device from FIG. 2 could for example also be positioned in a housing, not shown in FIG. 2, wherein a pressure of less than 1013 hPa prevails in the housing, wherein additionally or alternatively a protective gas atmosphere is present. For this purpose, the housing could for example be formed gas-tight and connected to a vacuum pump which can reduce the pressure within the housing. By the negative pressure thus generated, for example, friction losses, such as those caused between the rotating mixing container or the shaft 130 and the air in the housing, could be reduced and thus the efficiency of the device increased. A protective gas atmosphere in the housing could for example prevent or at least reduce oxidation reactions of the individual fluids or of the fluid mixture. It is likewise conceivable that, instead of the entire device, individual components, such as the mixing container 110, are arranged in the housing or only the part of the housing in which the mixing container 110 is located has a reduced pressure or a protective gas atmosphere.

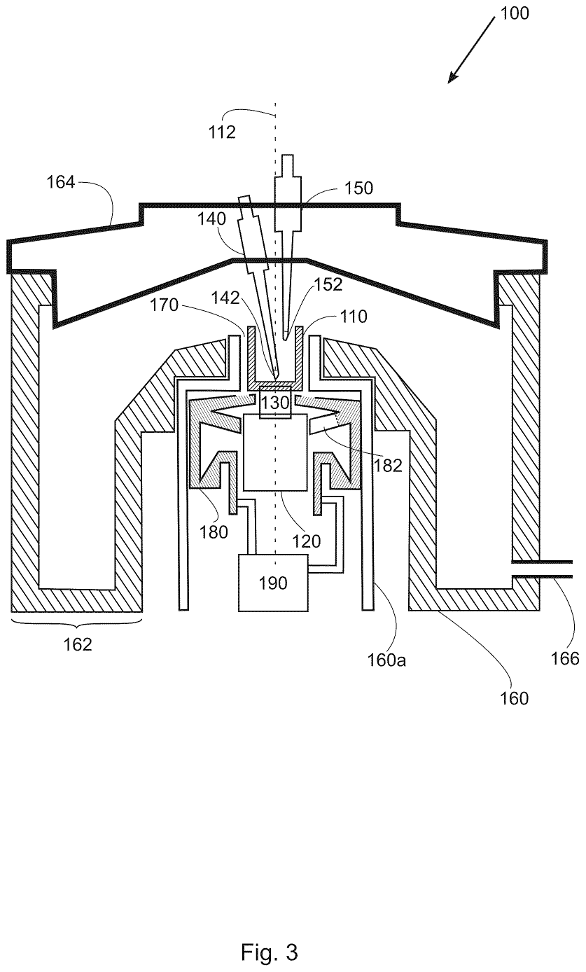

FIG. 3 shows a sectional illustration of a further example of a device for mixing at least one first and one second fluid. The device substantially resembles the exemplary device in FIG. 2, which is why repetition of the detailed description of the configuration of functionally similar or identical features or elements and any corresponding advantages is dispensed with. Everything stated in the detailed description of the device in FIG. 2 can likewise be transferred to the device in FIG. 3. Compared with that from FIG. 2, the device shown in the non-limiting example in FIG. 3 comprises at least an inner enclosure 160a, a lid 164, and an outlet 166.

The inner enclosure 160a is for example formed free-standing. Alternatively or additionally thereto, the inner enclosure 160a could be fastened to an element of the device, such as the discharge channel 180 or the drive unit 120. The inner enclosure 160a could for example serve to protect the drive unit 120 from fluid contact. In addition, it could for example serve as a fastening point for the enclosure 160, or the enclosure 160 could sit on contact surfaces of the inner enclosure 160a and thus for example ensure the correct seat of the enclosure 160. The lid 164 could for example consist of the same material as the enclosure 160, in particular of metal, for example stainless steel, or of a plastic, such as PTFE or polypropylene. In the present exemplary embodiment, the lid 164 is configured as a separate component which can be placed onto the enclosure 160 by means of partial form fit. In this regard, the lid 164 closes the interior of the enclosure 160, for example, in a gas-tight or at least substantially gas-tight manner. Additionally or alternatively to the partial form fit, for example, a latching connection, a snap closure, or a clamping device could be provided in order to fasten the lid 164 to the enclosure 160. For example, the first and the second feed unit 140 or 150 are guided through recesses in the lid 164 in order to be able to introduce the respective outlet 142 or 152 of the feed units into the mixing container 110. In this regard, the gas-tight closure could be ensured by means of seals in the recesses of the lid 164. For example, no component could also be guided through the lid 164 and the latter accordingly have no recesses.

The outlet 166 on the right lower side of the enclosure 160 in FIG. 3 serves for example to convey the fluid mixture out of the reservoir 162, in other words: to remove the fluid mixture. For example, the outlet could be equipped with a closable opening, for instance a valve, a sliding device, or a shut-off flap, in order to regulate the flow of the fluid mixture out of the reservoir, for example to filtration, cooling, a storage container, or a larger collecting container. For example, with the aid of the lid 164, the interior of the enclosure 160 could be flooded with protective gas, for instance via the gas feed unit 190. The protective gas could leave the enclosure 160 via the outlet 166, whereby formation of an overpressure in the enclosure 160 is prevented. The protective gas could for example protect the motor and its bearings from penetrating liquids or aerosols and bring about protection against oxidative stress in the mixing container 110 or in the entire interior of the enclosure 160.

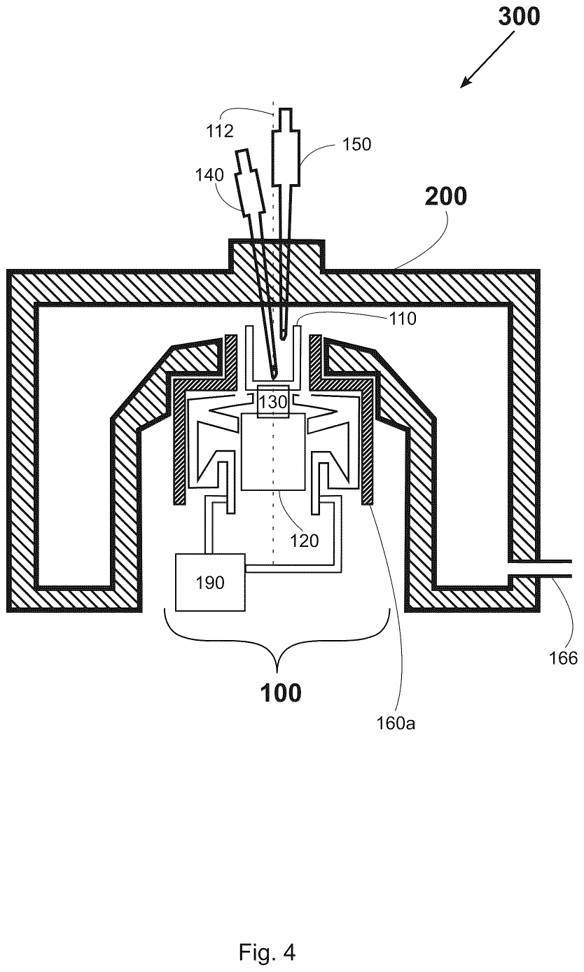

FIG. 4 shows a sectional illustration of an exemplary system 300 for fluid mixing. The device 100, which is part of the system 300, substantially resembles the exemplary device in FIG. 2, which is why repetition of the detailed description of the configuration of functionally similar or identical features or elements and any corresponding advantages is dispensed with. Everything stated in the detailed description of the device 100 in FIG. 2 can likewise be transferred to the device 100 in FIG. 4. The device 100 is for example arranged within an enclosure, wherein the closure element 200 could form a part of this enclosure. For example, as shown in FIG. 4, the other part of the enclosure is formed by the inner enclosure 160a. The closure element 200 could for example be connected by force fit to one of those parts of the enclosure which are not formed by the closure element 200, in the example of FIG. 4 therefore to the inner enclosure 160a.

The feed units 140, 150 could be integral components of the closure element 200. For example, the feed units 140, 150 could each comprise a cannula/hollow needle, wherein at least the cannula/hollow needle or further parts of the feed units 140, 150 can be cohesively connected to the closure element 200. This could for example be realized by an injection molding method, wherein the cannula/hollow needle is positioned and correspondingly oriented in the injection mold for the closure element before the plastic is introduced into the injection mold. An alternative manufacturing method for such components could be 3D printing, in which at least the cannula/hollow needle or further parts of the feed unit are embedded and fixed during printing between individual layers of the 3D printing. The feed units 140, 150 could likewise for example be positioned in a positionally fixed manner in the closure element 200 by means of a bayonet connection, a screw connection, or a clamping or latching connection with stop points.

With such a combination of feed unit 140, 150 and closure element 200, the outlets 142, 152 of the feed units 140, 150 could for example be positioned precisely within the mixing container 110 in a simple and repeatable manner. This could for example be achieved by connecting the closure element 200 to the inner enclosure 160a, for example by means of force fit. Other types of connection, such as bayonet, screw, or a clamping or latching connection with stop points, are also conceivable for this. Thus, for example, a predefined small distance between the outlet of the first feed unit 140 and the bottom of the mixing container 110 could be ensured, and the first outlet 142 could be positioned in the axis of rotational symmetry 112 of the mixing container 110. Likewise, in this way, the distance of the second outlet 152 of the second feed unit 150 from the inner wall of the mixing container 110 could be fixed in a range particularly favorable for operation. For different fluids or combinations of fluids, prefabricated closure parts 200 could thus in each case be provided in order to be able to position the feed units 140, 150 precisely in a simple and repeatable manner.

It is likewise conceivable that such a closure element 200 is designed for specific fluids and, due to the easy exchangeability of the closure element 200, the device 100 could be converted quickly and flexibly for mixing other fluids without there being a risk of contamination with old fluids or liquid fluid mixture. This could be advantageous in particular for pharmaceutical manufacturing purposes or the mixing of mutually reacting fluids, since in both cases the objective is to avoid contamination with preceding fluids. Not only could the purity of the corresponding fluid mixture thus be increased by avoiding or at least reducing contamination with other fluids, but the flexibility of the system 300 with respect to different types of fluids could also be increased. For example, a closure element 200 including feed units 140, 150 could be designed for a specific solvent in that it is made of a material resistant to this solvent. When changing to other fluids to be mixed, for example, the closure element 200 including feed units 140, 150 could simply be replaced by a corresponding closure element 200 including feed units 140, 150 which is resistant to these other fluids, so that the system 300 could easily be prepared for mixing the other fluids. This could also be advantageous for handling fluids whose viscosities differ significantly, since viscosity may, for example, influence the distance to be maintained between the outlet and the bottom of the mixing container 110 and between the outlet and the inner wall of the mixing container 110. Through the use of different closure elements 200, the flexibility of the system 300 could thus also be increased in this regard.

For example, the closure element 200 and alternatively or additionally the feed units 140, 150 could consist substantially of a material suitable for thermal sterilization methods, in particular an autoclavable material, such as stainless steel, PEEK, polyether ether ketone, PTFE, polytetrafluoroethylene, polypropylene, PP, or polyethylene, PE. In this way, sterilization could be facilitated, since autoclaves represent a widely used means for sterilization by means of steam, which could increase the hygiene level and additionally or alternatively enable reuse of the closure element 200, which in turn could increase sustainability and reduce operating costs.

For example, the closure element 200 and the feed units 140, 150 present as an integral component of the closure element 200 could be provided as sterile-packaged disposable articles, whereby handling of the system could be further facilitated and contamination of the fluids or of the fluid mixture further reduced. The same is for example also conceivable in each case for the closure element 200 and feed units 140, 150 present separately from it, wherein these could each be individually sterile-packaged.

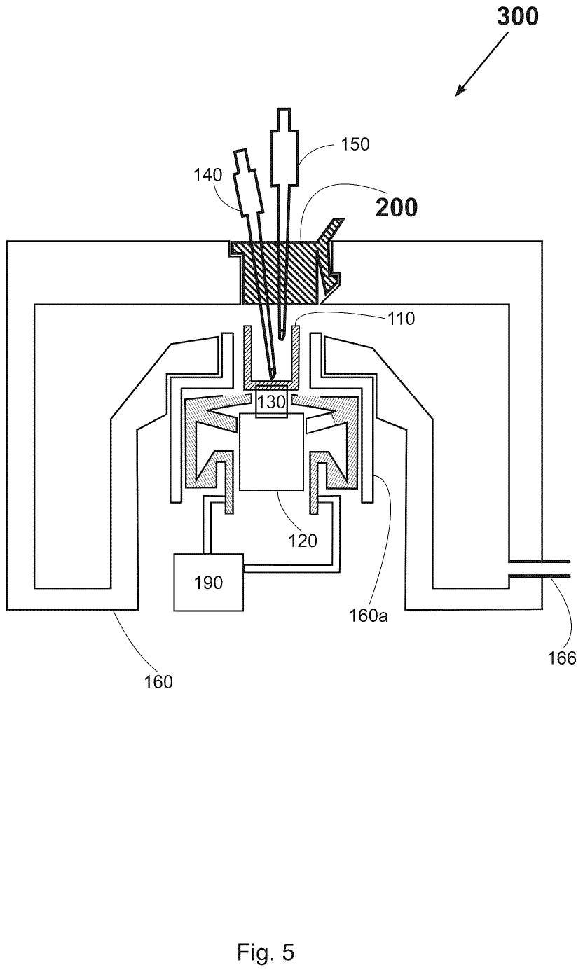

FIG. 5 shows a sectional illustration of a further example of a system 300 for fluid mixing. The system 300 substantially resembles the exemplary system 300 in FIG. 4, which is why repetition of the detailed description of the configuration of functionally similar or identical features or elements and any corresponding advantages is dispensed with. Everything stated in the detailed description of the system 300 in FIG. 4 can likewise be transferred to the system 300 in FIG. 5. Compared with FIG. 4, the closure element 200 in FIG. 5 has a smaller volume and can be positioned in a corresponding recess of an element of the enclosure 160. The closure element 200 could thus serve not only for positioning the feed units 140 and 150 but also for closing the enclosure 160. Owing to the reduced volume, the closure element 200 could contribute to reducing the material expenditure, which in turn could enable a reduction of manufacturing costs and improve the sustainability of the system.

In the non-limiting exemplary embodiment of FIG. 5, the closure element 200 is fastened to the enclosure 160 by means of a latching connection. This latching connection may for example be realized by a latching lug on the closure element 200 and a corresponding recess on the enclosure 160. This configuration could simplify handling of the system 300, in particular owing to the repeatable and easily releasable type of connection. In addition, the defined positioning of the closure element 200, and thus also of the feed units 140 and 150, within the mixing container 110 caused by the latching connection could enable precise, simple, and repeatable fixing of the outlets of the feed units 140 and 150 in the desired position and orientation.

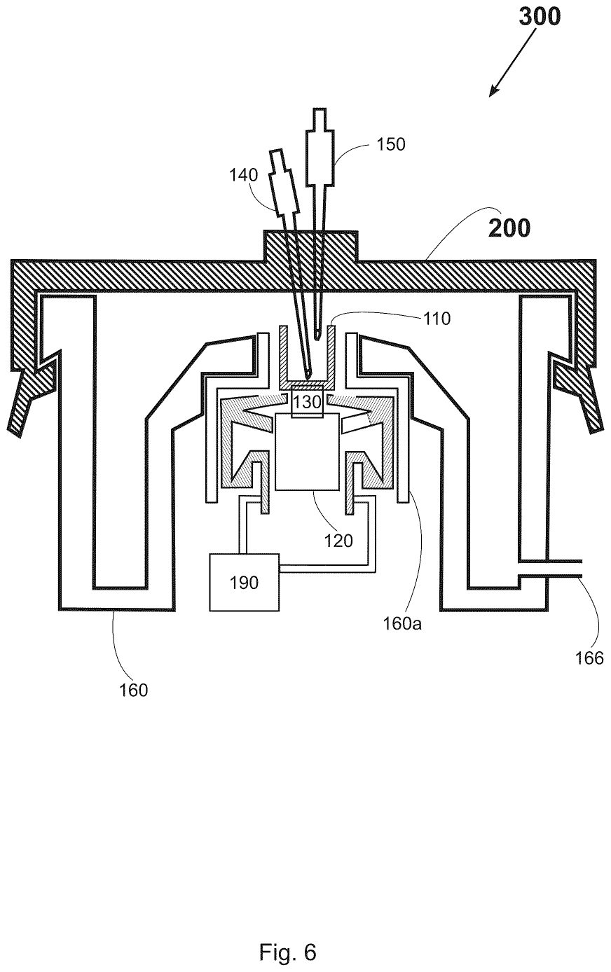

FIG. 6 shows a sectional illustration of a further example of a system 300 for fluid mixing. The system 300 substantially resembles the exemplary system 300 in FIG. 4, which is why repetition of the detailed description of the configuration of functionally similar or identical features or elements and any corresponding advantages is dispensed with. Everything stated in the detailed description of the system 300 in FIG. 4 can likewise be transferred to the system 300 in FIG. 6. Compared with the embodiment according to FIG. 4, the closure element 200 in FIG. 6 is connected to the enclosure 160 by means of a latching connection. In this way, not only reliable positioning of the feed units or their outlets could be ensured, but also the most gas-tight possible closure of the enclosure could be achieved. In FIG. 6, the distances between the closure element 200 and the adjacent elements of the enclosure 160 are shown enlarged purely for illustration purposes. In the practical embodiment, the corresponding distance between the closure element 200 and the enclosure 160 could be formed as small as possible in order to increase the tightness of the enclosure. It would likewise be conceivable that a seal is provided between the closure element 200 and corresponding elements of the enclosure 160, not shown in FIG. 6, in order to further increase the tightness of the enclosure.

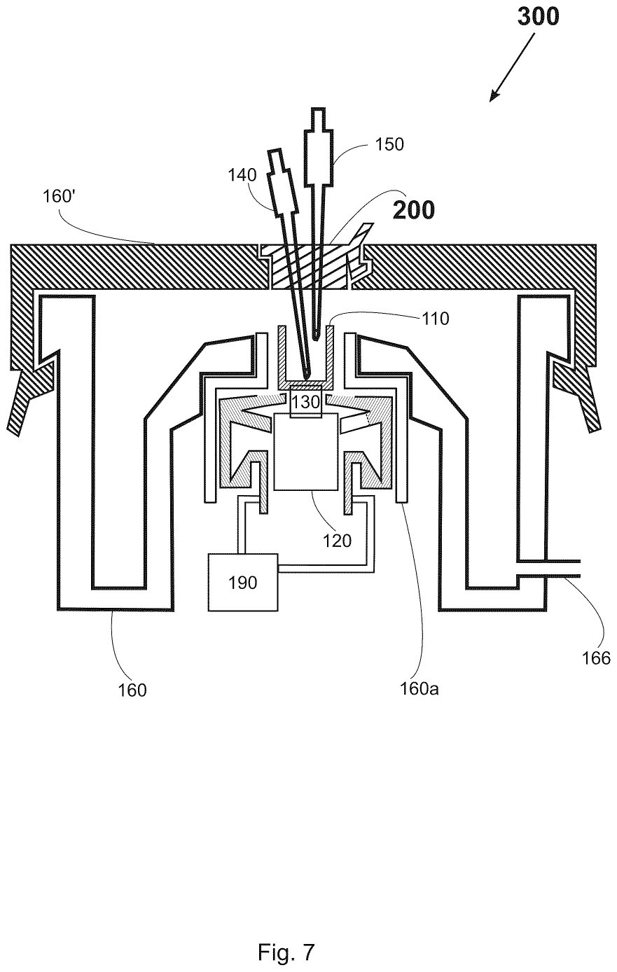

FIG. 7 shows a sectional illustration of a further example of a system 300 for fluid mixing. The system 300 substantially represents a combination of the systems 300 from FIGS. 5 and 6, which is why repetition of the detailed description of the configuration of functionally similar or identical features or elements and any corresponding advantages is dispensed with. Everything stated in the detailed description of the systems 300 in FIGS. 5 and 6 can likewise be transferred to the system 300 in FIG. 7. The closure element 200 corresponds to the exemplary embodiment shown in FIG. 5. In addition, in the system 300 in FIG. 7 it is provided that the enclosure 160 could be connected by means of a latching connection to a further enclosure 160′. In this way, the flexibility of the system 300 could be further increased while at the same time a gas-tight sealing as far as possible of the interior formed by the enclosures 160, 160′ and the inner enclosure 160a is maintained. For specific combinations of fluids or specific applications, it could for example be sufficient merely to exchange the closure element 200, alternatively only the enclosure 160 or 160′, or, depending on the requirement, both the closure element 200 and the corresponding enclosures.

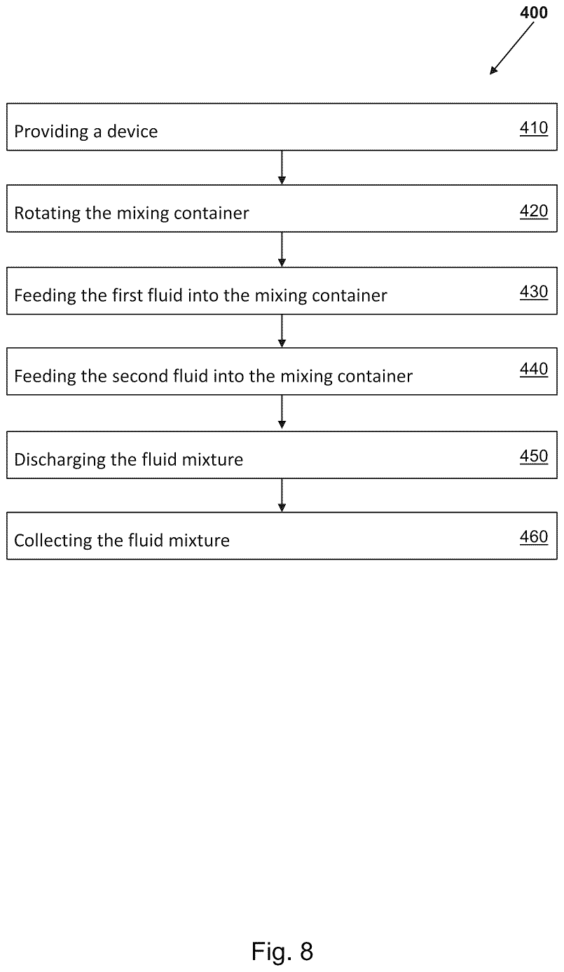

FIG. 8 shows a flow diagram of an exemplary method 400 for mixing at least one first and one second fluid, wherein the first fluid is a liquid. In block 410, a device according to any of the preceding claims is provided. In block 420, the mixing container is rotated about its axis of rotational symmetry, wherein this takes place in particular at a rotational speed of at least 150,000 rpm. In block 430, the first fluid is fed into the mixing container via the first feed unit. In block 440, the second fluid is fed into the mixing container via the second feed unit. In block 450, the fluid mixture produced in the mixing container is discharged tangentially outward via the upper opening of the mixing container. In block 460, the fluid mixture is either collected or fed to a filtration device. For example, the mixing container could first be rotated about its axis of rotational symmetry and then the first fluid fed. It would likewise be conceivable that first a certain quantity of the first fluid is fed to the mixing container and subsequently the mixing container is rotated about its axis of rotational symmetry.

For example, during the feeding of the first fluid, the distance of the first outlet from the bottom of the mixing container is selected such that a liquid bridge between a part of the first fluid located in the first outlet and a further part of the first fluid located in the mixing container is maintained. For example, the distance of the first outlet from the bottom of the mixing container could be actively controlled in such a manner that such a liquid bridge is maintained.

Embodiments of the invention comprise, for example, the following features:
1. Device for mixing at least one first and one second fluid having the following features:
   a mixing container rotatable about an axis of rotational symmetry,
   a drive unit, wherein the drive unit is configured to rotate the mixing container about the axis of rotational symmetry,
   a first feed unit having a first outlet, wherein the first feed unit is configured, during operation, to continuously feed the first fluid to the mixing container via the first outlet, wherein the first fluid is a liquid,
   a second feed unit having a second outlet, wherein the second feed unit is configured, during operation, to feed the second fluid to the mixing container via the second outlet,
   wherein the mixing container is open at its upper side in order to discharge a liquid fluid mixture tangentially outward.
2. Device according to Example 1, wherein the drive unit is configured to rotate the mixing container about its axis of rotational symmetry at a rotational speed ≥150,000 rpm, in particular ≥200,000 rpm, in particular ≥300,000 rpm, in particular ≥339,000 rpm.
3. Device according to any of the preceding examples, wherein the outlet of the first feed unit is positioned in the axis of rotational symmetry and the outlet of the second feed unit is positioned outside the axis of rotational symmetry.
4. Device according to any of the preceding examples, wherein the drive unit comprises a motor, wherein the motor is a brushless, permanent magnet three-phase motor or an induction motor with frequency converter or a compressed-air motor, and/or wherein the drive unit comprises a ceramic bearing, magnetic bearing, or air bearing.
5. Device according to any of the preceding examples, wherein the drive unit comprises a shaft and the mixing container is connected to the shaft of the drive unit by means of a press fit.
6. Device according to any of the preceding examples, wherein the mixing container is cylindrical, or wherein the mixing container is conical with an inner diameter increasing toward the bottom, and/or wherein the mixing container is smooth on the inside or comprises an upper inwardly beaded rim.
7. Device according to any of the preceding examples, wherein the mixing container consists substantially of titanium or a carbon-containing composite material.
8. Device according to any of the preceding examples, wherein the mixing container has a maximum inner diameter of ≤10 cm, in particular ≤1.5 cm, in particular ≤0.7 cm, and/or has a height in a range from 0.01 cm to 20 cm, in particular 0.1 cm to 10 cm, in particular 0.5 cm to 2 cm, in particular 0.7 cm to 1.2 cm.
9. Device according to any of the preceding examples, wherein the orientation of the mixing container or of the entire device is adjustable about three spatial axes.
10. Device according to any of the preceding examples, wherein the distance of the first outlet from the bottom of the mixing container is ≤1 mm, in particular ≤0.1 mm.
11. Device according to any of the preceding examples, wherein the mixing container is arranged in an enclosure, wherein the enclosure is configured to protect the drive unit from fluid contact and/or to collect liquid fluid mixture discharged tangentially from the mixing container, in particular wherein a gap for preventing contact between mixing container and enclosure is present between the outer wall of the mixing container and the inner wall of the enclosure, in particular wherein the gap has a width in the range from 0.05 mm to 0.5 mm, in particular from 0.2 mm to 0.4 mm.
12. Device according to Example 11, wherein, as additional protection of the drive unit from fluid contact, a discharge channel is arranged below the gap, wherein the discharge channel is spatially separated from the drive unit and receives the portion of the fluids or of the fluid mixture which has passed through the gap, in particular wherein the discharge channel consists of mutually connected, in particular labyrinth-like mutually connected, cavities, in particular wherein one of the cavities has a region in which a portion of the fluid received by the discharge channel remains.
13. Device according to Example 12 having a gas feed unit, wherein the gas feed unit is configured to conduct a gas through the gap and/or the discharge channel in order to protect these respectively from fluid entry.
14. Device according to any of the preceding examples, wherein the mixing container is positioned in a region in which a protective gas atmosphere is present and/or in which a negative differential pressure relative to the air pressure of the room in which the device is located prevails and/or wherein a pressure of less than 1013 hPa prevails in the region.
15. Device according to any of Examples 11 to 13, comprising a closure element, wherein the closure element forms at least a part of the enclosure and at least one of the feed units is an integral component of the closure element or can be positioned therein, in particular in a positionally fixed manner, in particular wherein the closure element is formed as an exchangeable component.
16. Device according to Example 15, wherein the closure element and/or the at least one of the feed units consists substantially of a material suitable for thermal sterilization methods, in particular autoclavable material.
17. System for fluid mixing, comprising
   a device according to any of Examples 1 to 14,
   a closure element for receiving at least one of the feed units, wherein the at least one of the feed units is an integral component of the closure element or can be positioned therein, in particular in a positionally fixed manner, and wherein the closure element forms at least a part of the enclosure.
18. System according to Example 17, wherein the closure element and/or the at least one of the feed units consists substantially of a material suitable for thermal sterilization methods, in particular autoclavable material.
19. Method for mixing at least one first and one second fluid, comprising:
   providing a system according to any of Examples 17 to 20,
   functionally connecting the closure element to the device,
   rotating the mixing container about its axis of rotational symmetry, in particular at a rotational speed ≥150,000 rpm,
   feeding the first fluid into the mixing container through the first feed unit, wherein the first fluid is a liquid,
   feeding the second fluid into the mixing container through the second feed unit,
   discharging the fluid mixture tangentially outward via the upper opening of the mixing container,
   collecting the fluid mixture and/or feeding the fluid mixture to a filtration device,
   wherein optionally the distance of the first outlet from the bottom of the mixing container is selected such that, during operation, a liquid bridge between the first fluid in the first outlet and the supplied first fluid in the mixing container is maintained.

Although the invention is illustrated and described in detail in the drawings and the foregoing description, this illustration and description are to be considered exemplary and not limiting. The invention is not limited to the disclosed examples.

Other variations of the disclosed examples can be understood and carried out by those skilled in the art in practicing the claimed invention on the basis of the drawings, the description, and the appended claims. In the claims, the word “comprising” does not exclude other elements or steps, and the indefinite article “a” or “an” does not exclude a plurality. The mere fact that certain features are mentioned in mutually different dependent claims does not mean that a combination of these features cannot be advantageous. Any reference signs in the claims should not be construed as limiting the scope of protection.

### LIST OF REFERENCE SIGNS

100 Device
110 Mixing container
112 Axis of rotational symmetry
114 Beaded rime
120 Drive unit
130 Shaft
140 First feed unit
142 First outlet
150 Second feed unit
152 Second outlet
160, 160′ Enclosure
160a Inner enclosure
162 Reservoir
164 Lid
166 Outlet
170 Gap
180 Discharge channel
182 Retention region
190 Gas feed unit
200 Closure element
300 System
400 Method
410 Providing a device
420 Rotating the mixing container about its axis of rotational symmetry
430 Feeding the first fluid into the mixing container
440 Feeding the second fluid into the mixing container
450 Discharging the fluid mixture
460 Collecting the fluid mixture

1. Device for mixing at least one first and one second fluid having the following features:
a mixing container rotatable about an axis of rotational symmetry,
a drive unit, wherein the drive unit is configured to rotate the mixing container about the axis of rotational symmetry,
a first feed unit having a first outlet, wherein the first feed unit is configured, during operation, to continuously feed the first fluid to the mixing container via the first outlet, wherein the first fluid is a liquid,
a second feed unit having a second outlet, wherein the second feed unit is configured, during operation, to feed the second fluid to the mixing container via the second outlet,
wherein the mixing container is open at its upper side in order to discharge a liquid fluid mixture tangentially outward and
wherein the drive unit is configured to rotate the mixing container about its axis of rotational symmetry at a rotational speed ≥150,000 rpm, in particular ≥200,000 rpm, in particular ≥300,000 rpm, in particular ≥339,000 rpm.

2. Device according to claim 1, wherein the first outlet of the first feed unit is positioned in the axis of rotational symmetry and the second outlet of the second feed unit is positioned outside the axis of rotational symmetry.

3. Device according to claim 1, wherein the drive unit comprises a motor, wherein the motor is a brushless, permanent magnet three-phase motor or an induction motor with frequency converter or a compressed-air motor, and/or wherein the drive unit comprises a ceramic bearing, magnetic bearing, or air bearing.

4. Device according to claim 1, wherein the drive unit comprises a shaft and the mixing container is connected to the shaft of the drive unit by means of a press fit.

5. Device according to claim 1, wherein the mixing container is cylindrical, or wherein the mixing container is conical with an inner diameter increasing toward the bottom, and/or wherein the mixing container is smooth on the inside or comprises an upper inwardly beaded rim.

6. Device according to claim 1, wherein the mixing container consists substantially of titanium or a carbon-containing composite material.

7. Device according to claim 1, wherein the mixing container has a maximum inner diameter of ≤10 cm, in particular ≤1.5 cm, in particular ≤0.7 cm, and/or has a height in a range from 0.01 cm to 20 cm, in particular 0.1 cm to 10 cm, in particular 0.5 cm to 2 cm, in particular 0.7 cm to 1.2 cm.

8. Device according to claim 1, wherein the orientation of the mixing container or of the entire device is adjustable about three spatial axes.

9. Device according to claim 1, wherein the distance of the first outlet from the bottom of the mixing container is ≤1 mm, in particular ≤0.1 mm.

10. Device according to claim 1, wherein the mixing container is arranged in an enclosure, wherein the enclosure is configured to protect the drive unit from fluid contact, in particular wherein a gap for preventing contact between mixing container and enclosure is present between the outer wall of the mixing container and the inner wall of the enclosure, in particular wherein the gap has a width in the range from 0.05 mm to 0.5 mm, in particular from 0.2 mm to 0.4 mm.

11. Device according to claim 10, wherein, as additional protection of the drive unit from fluid contact, a discharge channel is arranged below the gap, wherein the discharge channel is spatially separated from the drive unit and receives the portion of the fluids or of the fluid mixture which has passed through the gap, in particular wherein the discharge channel consists of mutually connected, in particular labyrinth-like mutually connected, cavities, in particular wherein one of the cavities has a retention region in which a portion of the fluid received by the discharge channel remains.

12. Device according to claim 11 having a gas feed unit, wherein the gas feed unit is configured to conduct a gas through the gap and/or the discharge channel in order to protect these respectively from fluid entry.

13. Device according to claim 1, wherein the mixing container is positioned in a region in which a protective gas atmosphere is present and/or in which a negative differential pressure relative to the air pressure of the room in which the device is located prevails and/or wherein a pressure of less than 1013 hPa prevails in the region.

14. Closure element for a device according to claim 1, wherein the closure element is designed for positioning at least one of the feed units, wherein the at least one of the feed units is an integral component of the closure element, or the closure element is configured to be able to position the at least one of the feed units, in particular in a positionally fixed manner, in particular wherein the closure element consists substantially of a material suitable for thermal sterilization methods, in particular autoclavable material.

15. (canceled)

16. Method for mixing at least one first and one second fluid, comprising:
providing a device according to claim 1,
rotating the mixing container about its axis of rotational symmetry, in particular at a rotational speed ≥150,000 rpm,
feeding the first fluid into the mixing container through the first feed unit, wherein the first fluid is a liquid,
feeding the second fluid into the mixing container through the second feed unit,
discharging the fluid mixture tangentially outward via the upper opening of the mixing container,
collecting the fluid mixture and/or feeding the fluid mixture to a filtration device, wherein optionally the distance of the first outlet from the bottom of the mixing container is selected such that, during operation, a liquid bridge between the first fluid in the first outlet and the supplied first fluid in the mixing container is maintained.
